(19) United States
(12) Patent Application Publication
(10) Pub. No.: US 2005/0126867 A1
(43) Pub. Date: Jun. 16, 2005

(54) Sealing device for a slack adjuster

(75) Inventors: John H. Crume, Elkhart, IN (US); Omar J. Fakhoury, Rockford, IL (US); Reginal A. Pete, Caledonia, IL (US); Charles E. Fritts, Roscoe, IL (US)

Correspondence Address: Michael Best & Friedrich LLC, Suite 1900, 401 North Michigan Avenue, Chicago, IL, 60611, US

(73) Assignee: Gunite Corporation, Rockford, IL (US)

(21) Appl. No.: 10/734,495

(22) Filed: Dec. 12, 2003

(51) Int. Cl. F16D 65/38

(52) U.S. Cl. 188/196 R

(57) ABSTRACT

A slack adjuster includes a boot to inhibit contamination of the slack adjuster and prolong the lifetime of a vehicle braking system. The boot includes an expandable bellows, a first seal integrally formed with the bellows and a second seal integrally formed with the bellows. The second seal is positionable in the cavity of the body and includes a boss. The boss is engageable with the lip to inhibit removal of the second seal from the cavity. The second seal of the boot is inserted into the cavity, and a link is inserted through the boot and into the cavity after the seal is inserted into the cavity.

### FIELD OF THE INVENTION

The present invention relates to sealing boots and, more particularly, to sealing boots for slack adjusters used with vehicle braking systems.

### BACKGROUND OF THE INVENTION

Slack adjusters are commonly used with vehicular braking systems to take up the excess spacing or slack that occurs between the parts of a braking system after a significant amount of use and wear. Braking systems including slack adjusters, however, are exposed to a variety of road and environmental conditions that can cause contamination of their inner workings and reduce their effectiveness. Various sealing devices have been used to attempt to inhibit contamination of the inner workings of slack adjusters. Such sealing devices often comprise several components. For example, some conventional sealing devices for slack adjusters include boots, seals, and connection brackets or other connection devices to connect the boots and seals to one another and to the slack adjuster. Often, one or more of the connections between the components or between the components and the slack adjuster is prone to mechanical failure or dislodgement, thereby allowing the inner workings of the slack adjuster to become exposed to road dirt or rust and thereby contaminated. Accordingly, there is a desire for a sealing device that effectively inhibits contamination of a slack adjuster.

### SUMMARY OF THE INVENTION

The present invention provides a boot for a slack adjuster. The slack adjuster includes a link and a body that defines a cavity and a lip. The boot includes a plurality of expandable folds comprising a bellows and a first seal integrally formed with the bellows on a first end. The first seal is engageable with the link. The boot also has a boss and a second seal integrally formed with the bellows on a second end. The second seal is positionable in the cavity of the body and is engageable with the link. The boss is engageable with the lip of the body to inhibit removal of the second seal from the cavity.

The slack adjuster also has a radially inwardly extending lip that at least partially closes an opening of the cavity and a boot that includes a seal and a plurality of folds comprising a bellows. The seal has a boss and is positionable in the cavity. The boss is engageable with the lip to inhibit removal of the seal from the cavity.

The present invention further provides a method of assembling a slack adjuster, including providing a body of the slack adjuster, the body defining a cavity therein, providing a boot that includes a plurality of bellows and a seal integral with the plurality of bellows, inserting the seal of the boot into the cavity, and inserting a link through the boot and into the cavity after the seal is inserted into the cavity.

Additional features and advantages of the invention will become apparent to those skilled in the art upon review of the following detailed description, claims, and drawings.

### BRIEF DESCRIPTION OF THE DRAWINGS

FIG. 1 is a perspective view of a slack adjuster including a sealing device embodying the invention.

FIG. 2 is a partial exploded perspective view of the slack adjuster of FIG. 1 including the sealing device.

FIG. 3 is a partial cross-sectional view taken along line 3-3 in FIG. 1, shown with the slack adjuster in a retracted condition.

FIG. 4 is a partial cross-sectional view similar to the cross-sectional view shown in FIG. 3, shown with the slack adjuster in an extended condition.

The invention is not intended to be limited in its application to the details of the construction and arrangements of the components set forth in the following description or illustrated in the drawings. The invention is capable of other embodiments and of being practiced or carried out in various ways. Also, it is understood that the phraseology and terminology used herein is for the purpose of description and should not be regarded as limiting.

### DETAILED DESCRIPTION

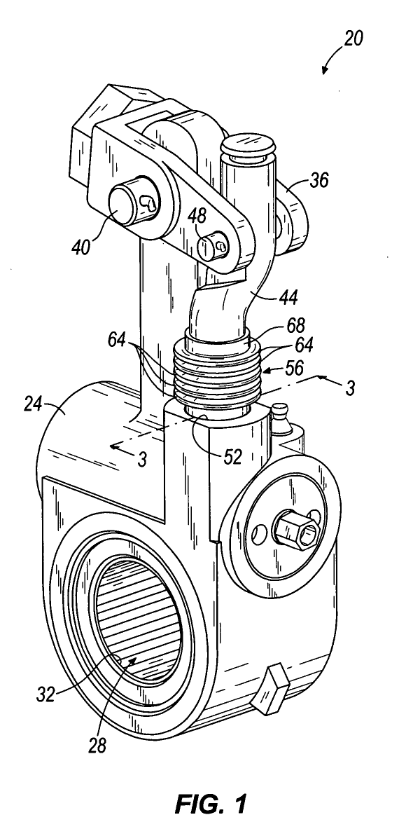

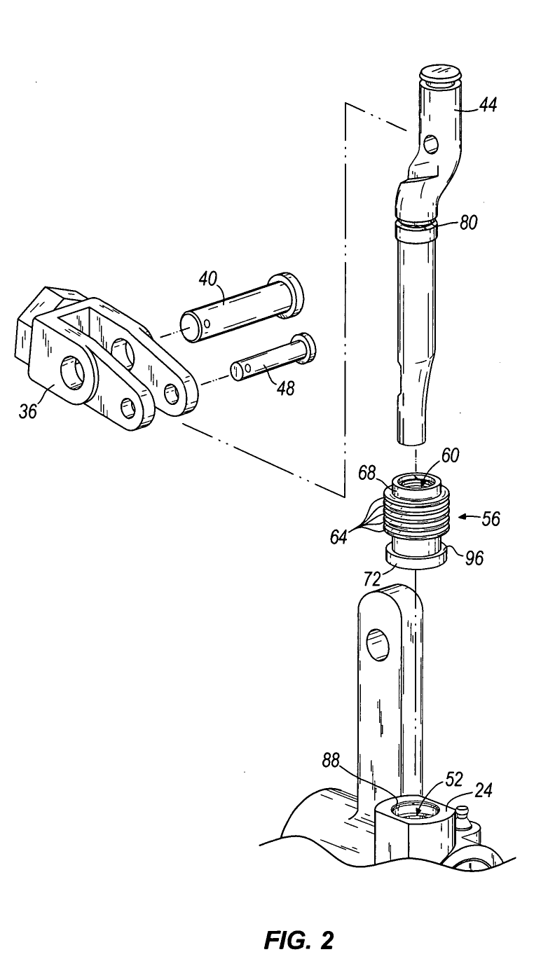

Referring to FIGS. 1 and 2, a slack adjuster 20, including a sealing device or boot 56, is useable with vehicular braking systems (not shown) to take-up the slack in the vehicular braking systems that occurs over time due to wearing of the brake pads, brake drums, and other components of the vehicular braking systems.

The slack adjuster 20 includes a body 24 with a shaft aperture 28 therethrough. A splined support 32 is positioned within the shaft aperture 28 to receive a camshaft or shaft (not shown) of the braking system. As will be known to those of skill in the art, the shaft may be an “S” camshaft, which refers to the manner in which the shaft brings about operation of the braking system. A yoke 36 is pivotally connected to the body 24 using a first pin connection 40 and is pivotally connected to a linking bar or link 44 using a second pin connection 48 to form a connection between internal slack adjusting components (not shown) of the slack adjuster 20 and the braking system (not shown). The braking systems and internal slack adjusting components are conventional and well known to those of ordinary skill in the art and, therefore, will not be discussed in greater detail herein except where reference thereto is necessary to describe the present invention.

With continued reference to FIGS. 1 and 2, the body 24 defines a cavity 52 into which the link 44 extends. The link 44 is axially movable within the cavity 52 and interacts with the internal slack adjusting components housed within the body 24. The slack adjuster 20 also includes a sealing device or sealing boot 56 that inhibits contamination of the cavity 52. The slack adjuster 20 may operate inappropriately or may be inoperable if contaminates, such as, for example oil, dirt, water, dust, etc., enter the cavity 52 and interfere with the internal slack adjusting components. Accordingly, the boot 56 inhibits such contaminates from entering the cavity 52 and contaminating the slack adjuster 20.

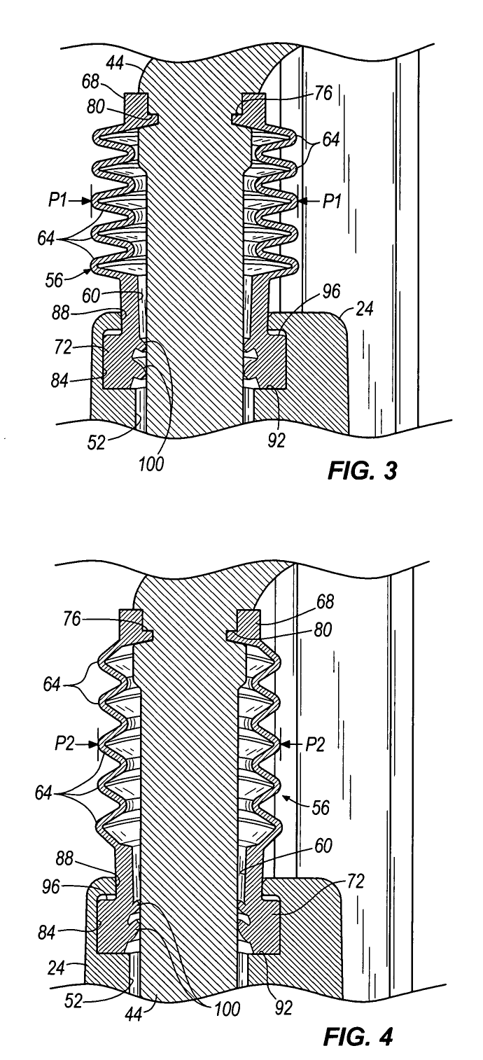

Referring now to FIGS. 2 and 3, the boot 56 is a single integral piece that defines a boot cavity 60 therethrough and includes a plurality of folds comprising a bellows 64, an upper seal 68 (as viewed in FIGS. 2 and 3) and a lower seal 72 (as viewed in FIGS. 2 and 3). The boot 56 is formed of a single material, which has a consistent hardness throughout. The boot 56 can be made of various types of elastic materials, and can have various hardnesses (e.g., 45 to 75 Shore A). In a preferred embodiment of the present invention, the boot 56 is made of Nitrile Butadiene Rubber (NBR), with a hardness of 45 to 65 Shore A. It should be understood, however, that the boot 56 can integrally be formed of a composite material that has portions of various hardnesses and still be within the spirit and scope of the present invention.

In the illustrated embodiment, the boot 56 includes five folds. The plurality of folds are expandable (see FIG. 4) to allow movement of the upper seal 68 with the link 44 (discussed in greater detail below) relative to the lower seal 72.

The upper seal 68 is positioned at an upper end (as viewed in FIGS. 2 and 3) of the bellows 64 and is engageable with the link 44. The upper seal 68 includes a lip 76 that is positionable within a recess 80 defined in the link 44 to connect the upper seal 68 to the link 44. The resiliency of the upper seal 68 is sufficient to maintain the lip 76 in the recess 80 during normal operation, but allow an operator to disconnect the upper seal 68 from the link 44 when desired. Accordingly, the upper seal 68 moves with the link 44 (discussed in greater detail below) during normal operation of the slack adjuster 20.

The lower seal 72 is positioned at a lower end (as viewed in FIGS. 2 and 3) of the bellows 64, within a seal cavity 84 defined in the body 24 between a lip 88 and a shoulder 92 of the body 24. The lip 88 partially closes off the opening to the seal cavity 84. The lower seal 72 includes a boss 96 that is positioned in the seal cavity 84 and engageable with the lip 88 of the body 24 to inhibit removal of the lower seal 72 from the seal cavity 84 when the link 44 is positioned within the boot 56. The lower seal 72 also includes a pair of flanges or projections 100 that extend therefrom and engage the link 44 to form a seal with the link 44. The engagement between the lower seal 72 and the link 44 inhibits contamination of the cavity 52. The projections 100 are resilient, which allows them to maintain engagement with the link 44 as the link 44 moves axially within the cavity 52. During axial movement of the link 44, the projections 100 engage an outer surface of the link 44 and wipe the outer surface. In other embodiments of the present invention, the lower seal 72 may include any number of projections 100 to create a seal between the projection(s) 100 and the link 44 and still be within the spirit and scope of the present invention.

With particular reference to FIGS. 2 and 3, the slack adjuster 20 is assembled by inserting the lower seal 72 of the boot 56 into the seal cavity 84. Depending on the exact configuration and type of material of the boot 56, the lower seal 72 may need to be folded or twisted in order to insert it past the lip 88 of the body 24 and into the seal cavity. In some embodiments of the present invention, the lower seal 72 may be made of a material sufficiently resilient to allow insertion of the lower seal 72 past the lip 88 of the body 24 and into the seal cavity 84 solely by biasing the lower seal 72 downward against the lip 88, without folding or twisting. The lower seal 72 may be inserted past the lip 88 and into the seal cavity 84 by deforming it in other manners and still be within the spirit and scope of the present invention.

Once the lower seal 72 is inserted into the seal cavity 84, the link 44 is inserted through the boot cavity 60 and into the cavity 52 of the body 24. As the link 44 is being inserted, the link 44 engages the lip 76 of the upper seal 68 and the projections 100 of the lower seal 72 and slides past the lip 76 and the projections 100. When the link 44 is properly positioned relative to the body 24, the lip 76 of the upper seal 68 engages the recess 80 and is maintained in the recess 80 due to the resiliency or press fit of the upper seal 68, thereby connecting the upper seal 68 to the link 44. The projections 100 engage the link 44 when the link 44 is properly positioned relative to the body 24 to create an effective seal with the link 44 and inhibit contamination of the cavity 52. The link 44 is then interconnected with the internal slack adjusting components (not shown) and the yoke 36 of the slack adjuster 20. With the link 44 positioned within the boot 56, the boss 96 of the boot 56 is snuggly positioned against the body 24 and is prevented from collapsing in on itself and disengaging from the lip 88 of the body 24. Therefore, the engagement between the lip 88 of the body 24 and the boss 96 of the lower seal 72 is ensured and inhibits removal of the lower seal 72 from the seal cavity 84.

FIGS. 3 and 4 show the operation of the slack adjuster 20 as it relates to the boot 56. The slack adjuster 20 can operate in a retracted condition (see FIG. 3), in which the link 44 is in a downward position and the folds of the bellows 64 of the boot 56 are compressed or unexpanded, and in an extended condition (see FIG. 4), in which the link 44 has moved from the downward position to an upward position and the upper seal 68 has moved upward with the link 44 to expand the folds of the bellows 64 of the boot 56. The connection between the upper seal 68 and the link 44 and the engagement of the lower seal 72 and the lip 88 of the body 24 facilitate movement of the upper seal 68 with the link 44 and facilitate movement of the upper seal 68 relative to the lower seal 72. In the illustrated embodiment, the five folds of the bellows 64 allow the boot 56 to expand approximately 0.25 inches per fold (approximately 1.25 inches overall). By including five folds in the bellows 64, the boot 56 has a slimmer retracted profile P1 (corresponding to the retracted condition of the slack adjuster 20) and a slimmer extended profile P2 (corresponding to the extended condition of the slack adjuster20) than a boot having fewer bellows and the same expansion capability. In other words, with all other variables being equal, a boot with fewer than five bellows and the same expansion capability will have retracted and extended profiles wider than the retracted and extended profiles P1, P2 of the boot 56.

When the slack adjuster 20 is initially connected to a new or relatively new braking system, the slack adjuster 20 is in the retracted condition because the braking system is not worn down and the slack adjuster 20 has no slack to take-up from the braking system. As the braking system begins to wear over time, the slack adjuster 20 takes up the slack in the braking system causing the link 44 to move upward and the slack adjuster 20 to move toward the extended condition. The two projections 100 continuously engage the outer surface of the link 44 in a “wiping” manner, sliding over the surface of the link 44, as the slack adjuster 20 moves between the retracted condition and the extended condition to inhibit contamination of the cavity 52. When the braking system has sufficiently worn down to the point that the slack adjuster can no longer function adequately, the braking system (or components of it) is replaced.

Although particular constructions of the present invention have been shown and described, other alternative constructions will be apparent to those skilled in the art and are within the intended scope of the present invention. Thus, the present invention is to be limited only by the claims.

1. A boot for a slack adjuster, the slack adjuster including a link and a body defining a cavity and having a lip, the boot comprising:
an expandable bellows;
a first seal integrally formed with the bellows on a first end of the bellows, the first seal being engageable with the link; and
a second seal integrally formed with the bellows on a second end of the bellows and including a boss, the second seal being positionable in the cavity of the body and engageable with the link, the boss being engageable with the lip of the body to inhibit removal of the second seal from the cavity.

2. The boot of claim 1, wherein the bellows, the first seal and the second seal are made of the same material.

3. The boot of claim 1, wherein the bellows includes five expandable folds.

4. The boot of claim 1, wherein the second seal includes two projections engageable with the link.

5. A slack adjuster comprising:
a body defining a cavity therein and including a lip at least partially surrounding an opening of the cavity and at least partially closing the opening of the cavity;
a link at least partially positioned within the cavity and axially movable within the cavity; and
a boot including a bellows, a first seal integral with the bellows and positioned on a first end of the bellows, and a second seal integral with the bellows and positioned on a second end of the bellows, the second seal engageable with the link and with the lip of the body, and wherein the link is movable relative to the second seal.

6. The slack adjuster of claim 5, wherein the bellows, the first seal and the second seal are made of the same material.

7. The slack adjuster of claim 6, wherein the material has a consistent hardness throughout.

8. The slack adjuster of claim 5, wherein the link defines a recess therein, the first seal being at least partially positionable within the recess to connect the first seal to the link.

9. The slack adjuster of claim 8, wherein the first seal is movable with the link, and wherein the first seal and the link are movable relative to the second seal.

10. The slack adjuster of claim 5, wherein the bellows includes five folds.

11. The slack adjuster of claim 5, wherein the second seal includes two projections engageable with the link.

12. The slack adjuster of claim 11, wherein the two projections wipe against a surface of the link when the link moves.

13. The slack adjuster of claim 5, wherein the first seal is engageable with the link externally of the cavity and the second seal is engageable with the link within the cavity.

14. A slack adjuster comprising:
a body defining a cavity and including a lip extending radially inwardly into the cavity; and
a boot including a seal and a bellows, the seal including a boss and being positionable in the cavity, the boss being engageable with the lip to inhibit removal of the seal from the cavity.

15. The slack adjuster of claim 14, wherein the seal is integral with the bellows.

16. The slack adjuster of claim 15, wherein the seal and the bellows are made of the same material, the material having similar hardness throughout.

17. The slack adjuster of claim 14, wherein the lip defines an end of the cavity.

18. The slack adjuster of claim 17, wherein the lip defines a top end of the cavity.

19. The slack adjuster of claim 14, further comprising a link at least partially positioned in the cavity and axially movable within the cavity.

20. The slack adjuster of claim 19, wherein the seal is engageable with the link.

21. The slack adjuster of claim 20, wherein the seal is engageable with the link within the cavity.

22. The slack adjuster of claim 14, wherein the seal is a first seal and is positioned on a first end of the bellows, the boot further including a second seal positioned on a second end of the bellows.

23. The slack adjuster of claim 22, wherein the first and second seals are integral with the bellows.

24. The slack adjuster of claim 22, further comprising a link at least partially positioned in the cavity and axially movable within the cavity, the link defining a recess therein, the second seal including a second seal lip that is positionable within the recess to connect the second seal to the link.

25. The slack adjuster of claim 24, wherein the first seal is engageable with the link within the cavity and the second seal is engageable with the link externally of the cavity.

26. A slack adjuster for use with vehicle brakes, the slack adjuster comprising:
a body defining a cavity therein and including a lip, the lip at least partially defining the cavity;
a link at least partially positioned in the cavity and axially movable within the cavity; and
a boot including a bellows, a first seal integral with the bellows on a first end of the bellows, the first seal engaging the link externally of the cavity for movement with the link, and a second seal integral with the bellows on a second end of the bellows and including a boss, the second seal being positionable within the cavity and engageable with the link within the cavity, the boss being engageable with the lip of the body.

27. The slack adjuster of claim 26, wherein the link defines a recess and the first seal includes a first seal lip that is positionable within the recess to engage the link and connect the first seal to the link.

28. The slack adjuster of claim 26, wherein the first seal, the bellows and the second seal are made of the same material, the material having similar hardness throughout.

29. The slack adjuster of claim 26, wherein the second seal includes projections engageable with the link within the cavity.

30. The slack adjuster of claim 26, wherein the bellows includes five folds.

31. A method of assembling a slack adjuster, the method comprising:
providing a body of the slack adjuster, the body defining a cavity therein;
providing a boot including a bellows and a seal integral with the bellows;
inserting the seal of the boot into the cavity; and
inserting a link through the boot and into the cavity after the seal is inserted into the cavity.

32. The method of claim 31, wherein providing a body further includes providing a body including a lip that at least partially defines the cavity, and wherein inserting the seal further includes inserting the seal past the lip and into the cavity, the method further comprising inhibiting removal of the seal from the cavity by engagement between the seal and the lip.

33. The method of claim 32, wherein the seal includes a boss, and wherein inhibiting removal includes inhibiting removal of the seal from the cavity by engagement between the boss and the lip.

34. The method of claim 31, further comprising engaging the seal with the link after inserting the link through the boot and into the cavity.

35. The method of claim 34, wherein engaging the seal with the link further includes engaging the seal with the link within the cavity.

36. The method of claim 31, wherein providing a boot further includes providing a boot including a seal including two projections, the method further comprising engaging the two projections of the seal with the link after inserting the link into the boot and the cavity.

37. The method of claim 31, wherein the seal is a first seal, and wherein providing a boot further includes providing a boot including a second seal integral with the bellows.

38. The method of claim 37, further comprising engaging the first and second seals with the link after inserting the link through the boot and into the cavity.

39. The method of claim 38, wherein engaging the first and second seals with the link further includes engaging the first seal with the link within the cavity and engaging the second seal with the link externally of the cavity.

40. The method of claim 37, wherein the second seal includes a second seal lip, the method further comprising positioning the second seal lip within a recess defined in the link after the link is inserted through the boot and into the cavity to connect the second seal to the link.

41. The method of claim 31, wherein providing a boot further includes providing a bellows including five folds.
